(19) United States
(12) Patent Application Publication
(10) Pub. No.: US 2025/0233952 A1
(43) Pub. Date: Jul. 17, 2025

(54) IMAGE READING APPARATUS CAPABLE OF READING SHADOWS GENERATED AT A LEADING EDGE OF A DOCUMENT, IMAGE FORMING APPARATUS, AND READING CONDITION ADJUSTMENT METHOD

(71) Applicant: KYOCERA Document Solutions Inc., Osaka (JP)

(72) Inventor: Yasushi Takatsuki, Osaka (JP)

(21) Appl. No.: 18/986,157

(22) Filed: Dec. 18, 2024

(30) Foreign Application Priority Data
Jan. 12, 2024 (JP) 2024-003049

(51) Int. Cl. H04N 1/00

(52) U.S. Cl. CPC H04N 1/00798

(57) ABSTRACT

An image reading apparatus includes an image sensor, an identification processing portion, and an adjustment processing portion. The image sensor has a first light emitting portion that emits light toward a reading position from a position on a conveying path of a document farther upstream in a conveying direction than the reading position, and outputs image data including an image of the document passing through the reading position using the first light emitting portion. The identification processing portion identifies the type of the image sensor. The adjustment processing portion, based on an identification result by the identification processing portion, adjusts, among reading conditions of the image of the document using the image sensor, specific conditions that are related to generation of a shadow that occurs when a leading edge of the document passes the reading position.

### INCORPORATION BY REFERENCE

This application is based upon and claims the benefit of priority from the corresponding Japanese Patent Application No. 2024-003049 filed on Jan. 12, 2024, the entire contents of which are incorporated herein by reference.

### BACKGROUND

The present disclosure relates to an image reading apparatus, an image forming apparatus, and a reading condition adjustment method.

Image reading apparatuses are known that are capable of reading an image on a document that is conveyed past a predetermined reading position.

### SUMMARY

An image reading apparatus according to an aspect of the present disclosure includes a document conveying portion, an image sensor, an identification processing portion, and an adjustment processing portion. The document conveying portion conveys a document along a predetermined conveying path. The image sensor has a first light emitting portion that emits light toward a predetermined reading position on a conveying path from a position farther upstream in a conveying direction of the document than the reading position, and outputs image data including an image of the document passing through the reading position using the first light emitting portion. The identification processing portion identifies the type of the image sensor. The adjustment processing portion, based on an identification result by the identification processing portion, adjusts, among reading conditions of the image of the document using the image sensor, specific conditions that are related to generation of a shadow that occurs when a leading edge of the document passes the reading position.

An image forming apparatus according to another aspect of the present disclosure includes the image reading apparatus, and forms an image on a sheet based on the image data output from the image reading device.

A reading condition adjustment method according to another aspect of the present disclosure is executed by an image reading apparatus including: a document conveying portion configured to convey a document along a predetermined conveying path; and an image sensor including a first light emitting portion that emits light toward a predetermined reading position on the conveying path from a position on the conveying path farther upstream in a conveying direction of the document than the reading position; and configured to output image data including an image of the document passing through the reading position using the first light emitting portion; the reading condition adjustment method including an identification step and an adjustment step. In the identification step, a type of the image sensor is identified. In the adjustment step, based on an identification result by the identification step, specific conditions among reading conditions of the image of the document using the image sensor that are related to generation of a shadow that occurs when a leading edge of the document passes the reading position are adjusted.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a system configuration of an image forming apparatus according to an embodiment of the present disclosure.

FIG. 2 is a diagram showing a configuration of an ADF and image reading portion of an image forming apparatus according to an embodiment of the present disclosure.

FIG. 3 is a diagram showing a configuration of a second imaging portion of an image forming apparatus according to an embodiment of the present disclosure.

FIG. 4 is a flowchart showing an example of a reading condition adjustment process executed by an image forming apparatus according to an embodiment of the present disclosure.

### DETAILED DESCRIPTION

Hereinafter, an embodiment of the present disclosure will be described with reference to the accompanying drawings. Note that the following embodiment is merely an example of the present disclosure and does not limit the technical scope of the present disclosure.

### [Configuration of Image Forming Apparatus 100]

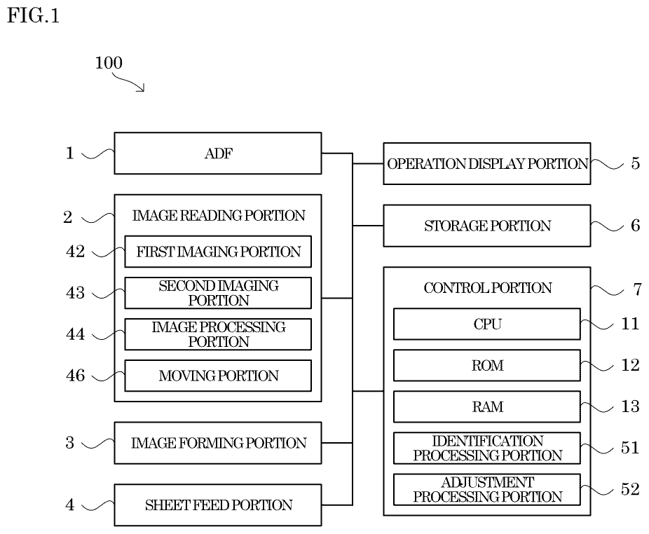

First, with reference to FIG. 1, a configuration of an image forming apparatus 100 according to an embodiment of the present disclosure will be described.

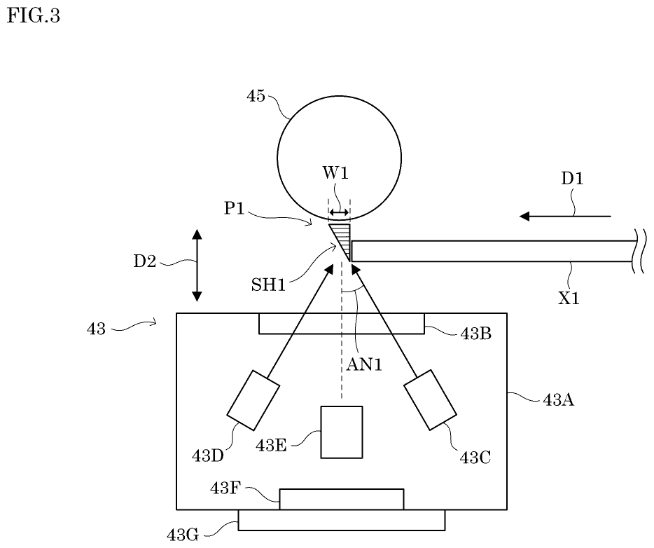

The image forming apparatus 100 is a multifunction peripheral having multiple functions, such as a scanning function for reading an image from a document X1 (see FIG. 3), a printing function for forming an image on a sheet based on image data, a fax function, and a copy function. Note that the image forming apparatus of the present disclosure may be a fax machine or a copier.

As shown in FIG. 1, the image forming apparatus 100 includes an auto document feeder (ADF) 1, an image reading portion 2, an image forming portion 3, a sheet feed portion 4, an operation display portion 5, a storage portion 6, and a control portion 7.

The ADF 1 conveys a document X1 whose image is to be read by the scanning function.

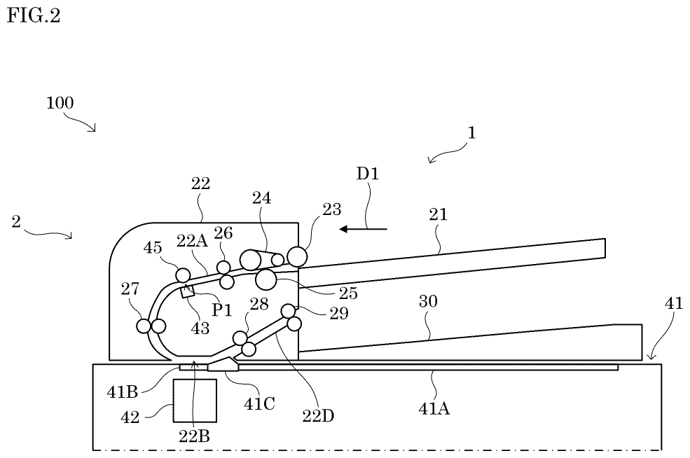

The image reading portion 2 achieves the scanning function. More specifically, the image reading portion 2 reads an image from the document X1 conveyed by the ADF 1. In addition, the image reading portion 2 also reads an image from a document X1 placed on a document table 41 (see FIG. 2).

The image forming portion 3 achieves the printing function. For example, the image forming portion 3 forms an image on a sheet fed from the sheet feed portion 4 by an electrophotographic method. For example, the image forming portion 3 includes a photoconductor drum, a charging roller, a laser scanning unit, a developing device, a transfer roller, a cleaning device, and a fixing device. The image forming apparatus 100 uses the image forming portion 3 to form an image on a sheet based on image data output from the image reading portion 2. Note that the image forming portion 3 may form an image on a sheet by a method other than an electrophotographic method, such as an inkjet method.

The sheet feed portion 4 feeds sheets to the image forming portion 3. For example, the sheet feed portion 4 includes a sheet feed cassette, a manual feed tray, a sheet conveying path, and a plurality of conveying rollers.

The operation display portion 5 is a user interface of the image forming apparatus 100. The operation display portion 5 includes a display portion and an operation portion. The display portion displays various types of information in response to control instructions from the control portion 7. For example, the display portion is a liquid crystal display. The operation portion inputs various types of information to the control portion 7 in response to a user operation. For example, the operation portion is a touch panel.

The storage portion 6 is a non-volatile storage device. For example, the storage portion 6 is a non-volatile memory such as a flash memory. Note that the storage portion 6 may be a solid state drive (SSD) or a hard disk drive (HDD).

The control portion 7 performs overall control of the image forming apparatus 100. As shown in FIG. 1, the control portion 7 includes a CPU 11, a ROM 12, and a RAM 13. The CPU 11 is a processor that executes various types of arithmetic processes. The ROM 12 is a non-volatile storage device in which information such as a control program for causing the CPU 11 to execute various types of processes is stored in advance. The RAM 13 is a volatile or non-volatile storage device used as a temporary storage memory (work area) for various types of processes executed by the CPU 11. In the control portion 7, the CPU 11 executes various types of control programs that are stored in advance in the ROM 12. Thus, the control portion 7 performs overall control of the image forming apparatus 100. Note that the control portion 7 may be configured with an electronic circuit such as an application specific integrated circuit (ASIC). In addition, the control portion 7 may be a control portion provided separately from a main control portion that performs overall control of the image forming apparatus 100.

### [Configuration of ADF 1 and Image Reading Portion 2]

Next, the configuration of the ADF 1 and the image reading portion 2 will be described with reference to FIGS. 1 to 3. Here, FIG. 2 is a cross-sectional view showing the configuration of the ADF 1 and the image reading portion 2. In addition, FIG. 3 is a cross-sectional view showing the configuration of a second imaging portion 43. Note that in FIG. 3, a shadow SH1 is hatched.

As shown in FIG. 2, the ADF 1 includes a document placement portion 21, a housing 22, a pickup roller 23, a sheet feed belt 24, a separation roller 25, a registration roller 26, a first conveying roller 27, a second conveying roller 28, a discharge roller 29, and a discharge portion 30.

On the document placement portion 21, a document X1 to be conveyed is placed. In the ADF 1, the document X1 placed on the document placement portion 21 is conveyed in a conveying direction D1 shown in FIG. 2.

The document placement portion 21 is provided with a lift plate (not shown). The lift plate lifts one or a plurality of documents X1 placed on the document placement portion 21 up to a contact position with the pickup roller 23.

The housing 22 houses rollers and the like used for conveying the document X1. As shown in FIG. 2, a conveying path 22A is formed inside the housing 22. The conveying path 22A guides the document X1 along a predetermined conveying path. More specifically, the conveying path is a path that extends from the document placement portion 21 to the discharge portion 30 via the reading position P1 (see FIG. 2) and an opening portion 22B (see FIG. 2).

As shown in FIG. 2, the housing 22 has an opening portion 22B at a bottom portion thereof. The opening portion 22B exposes a surface of the document X1 conveyed along the conveying path. The surface of the document X1 placed on the document placement portion 21 facing upward is a front surface of the document X1. At the opening portion 22B, the image on the front surface of the document X1 being conveyed by the ADF 1 is read by a first imaging portion 42 (see FIGS. 1 and 2) of the image reading portion 2.

As shown in FIG. 2, the pickup roller 23 is provided above the document placement portion 21. The pickup roller 23 comes into contact with the front surface (top surface) of the uppermost document X1 of one or more documents X1 lifted by the lift plate, and conveys the document X1 in the conveying direction D1.

As shown in FIG. 2, the sheet feed belt 24 is provided in the conveying path 22A. The sheet feed belt 24 comes into contact with the front surface of the document X1 being conveyed in the conveying direction D1 by the pickup roller 23, and conveys the document X1 downstream in the conveying direction D1.

As shown in FIG. 2, the separation roller 25 is provided below the sheet feed belt 24 and comes in contact with the sheet feed belt 24. Of the plurality of documents X1 that are conveyed to a contact position with the sheet feed belt 24, the separation roller 25 separates the document X1 that is in contact with the sheet feed belt 24 from the documents X1 below it.

As shown in FIG. 2, the registration roller 26 is provided on the conveying path 22A farther downstream in the conveying direction D1 than the sheet feed belt 24 and farther upstream in the conveying direction D1 than the first conveying roller 27. The registration roller 26 comes into contact with the document X1 being conveyed by the sheet feed belt 24, and conveys the document X1 downstream in the conveying direction D1.

As shown in FIG. 2, the first conveying roller 27 is provided on the conveying path 22A farther downstream in the conveying direction D1 than the registration roller 26 and farther upstream in the conveying direction D1 than the second conveying roller 28. The first conveying roller 27 comes into contact with the document X1 being conveyed by the registration roller 26, and conveys the document X1 downstream in the conveying direction D1.

As shown in FIG. 2, the opening portion 22B is formed in the conveying path 22A farther downstream in the conveying direction D1 than the first conveying roller 27 and farther upstream in the conveying direction D1 than the second conveying roller 28. At the opening portion 22B, the first imaging portion 42 (see FIGS. 1 and 2) of the image reading portion 2 reads an image on the front surface of the document X1 passing through the opening portion 22B.

As shown in FIG. 2, the second conveying roller 28 is provided on the conveying path 22A farther downstream in the conveying direction D1 than the opening portion 22B and farther upstream in the conveying direction D1 than the discharge roller 29. The second conveying roller 28 comes into contact with the document X1 being conveyed by the first conveying roller 27, and conveys the document X1 downstream in the conveying direction D1.

As shown in FIG. 2, the discharge roller 29 is provided on the conveying path 22A farther downstream in the conveying direction D1 than the second conveying roller 28. The discharge roller 29 comes into contact with the document X1 being conveyed by the second conveying roller 28, and discharges the document X1 to the discharge portion 30. The document X1 discharged by the discharge roller 29 is stacked on the discharge portion 30.

In the ADF 1, the document X1 placed on the document placement portion 21 is conveyed along the conveying path by the pickup roller 23, the sheet feed belt 24, the registration roller 26, the first conveying roller 27, the second conveying roller 28, and the discharge roller 29. The pickup roller 23, the sheet feed belt 24, the registration roller 26, the first conveying roller 27, the second conveying roller 28, and the discharge roller 29 are an example of a document conveying portion of the present disclosure.

As shown in FIGS. 1 and 2, the image reading portion 2 includes the document table 41, the first imaging portion 42, the second imaging portion 43, the image processing portion 44, a shading roller 45, and a moving portion 46.

A document X1 to be read is placed on the document table 41. The document table 41 is provided at an upper portion of the housing of the image forming apparatus 100 (see FIG. 2). The ADF 1 is provided so as to be openable and closable with respect to the document table 41, and also serves as a document cover that supports one surface of the document X1 placed on a first contact glass 41A of the document table 41.

As shown in FIG. 2, the document table 41 includes the first contact glass 41A, a second contact glass 41B, and a guide member 41C. A document X1, an image of which is to be read by the first imaging portion 42, is placed on the first contact glass 41A. In a case in which the document table 41 of the ADF 1 is closed, the second contact glass 41B and the guide member 41C close the opening portion 22B of the housing 22 and form a part of the conveying path 22A. The second contact glass 41B transmits light emitted from the first imaging portion 42 toward the opening portion 22B and transmits light reflected from the front surface of the document X1. The guide member 41C guides the document X1 to the second conveying roller 28 farther downstream in the conveying direction D1 than the second contact glass 41B.

As shown in FIG. 2, the first imaging portion 42 is provided below the first contact glass 41A and the second contact glass 41B. The first imaging portion 42 is elongated in the depth direction of the paper in FIG. 2, and is provided so as to be movable in the left-right direction of the sheet in FIG. 2. The first imaging portion 42, in a state of being arranged below the second contact glass 41B, reads an image of the front surface of the document X1 being conveyed by the ADF 1. More specifically, the first imaging portion 42 is a contact image sensor (CIS). The first imaging portion 42 outputs image data including an image read from the front surface of the document X1.

As shown in FIG. 2, the second imaging portion 43 is provided on the conveying path 22A farther downstream in the conveying direction D1 than the registration roller 26 and farther upstream in the conveying direction D1 than the first conveying roller 27. The second imaging portion 43 is elongated in the depth direction of the paper surface in FIG. 2. The second imaging portion 43 is provided on a side of the conveying path 22A facing the back surface of the document X1. The second imaging portion 43 reads an image of the back surface of the document X1. More specifically, the second imaging portion 43 is a CIS. The second imaging portion 43 outputs image data including an image read from the back surface of the document X1.

As shown in FIG. 3, the second imaging portion 43 includes a housing 43A, a light transmitting portion 43B, a first light emitting portion 43C, a second light emitting portion 43D, a lens 43E, a photoelectric conversion portion 43F, and an analog front end (AFE) 43G.

The housing 43A houses the first light emitting portion 43C, the second light emitting portion 43D, the lens 43E, and the photoelectric conversion unit 43F. For example, the housing 43A is formed in a box shape that is elongated in the depth direction of the paper surface in FIG. 3. The AFE 43G is provided on a bottom surface of the housing 43A. An opening portion that is elongated in the depth direction of the paper surface in FIG. 3 is formed in an upper portion of the housing 43A. The light transmitting portion 43B is provided in the opening portion.

The light transmitting portion 43B is a transparent member that closes the opening portion of the housing 43A. For example, the light transmitting portion 43B is a glass plate. The light transmitting portion 43B transmits the light emitted from the first light emitting portion 43C and the second light emitting portion 43D. In addition, the light transmitting portion 43B transmits light that is emitted from the first light emitting portion 43C and the second light emitting portion 43D and is reflected by the document X1 passing through the reading position P1.

As shown in FIG. 3, the first light emitting portion 43C emits light toward the reading position P1 from a position on the conveying path farther upstream in the conveying direction D1 of the document X1 than the predetermined reading position P1 (see FIGS. 2 and 3). For example, the first light emitting portion 43C is a light emitting diode that emits white light.

As shown in FIG. 3, the second light emitting portion 43D emits light toward the reading position P1 from a position on the conveying path farther downstream in the conveying direction D1 than the reading position P1 (see FIGS. 2 and 3). For example, the second light emitting portion 43D is a light emitting diode that emits white light.

The lens 43E collects the light emitted from the first light emitting portion 43C and the second light emitting portion 43D and reflected by the document X1 passing through the reading position P1 onto the photoelectric conversion portion 43F.

The photoelectric conversion portion 43F outputs an analog electrical signal based on the light emitted from the first light emitting portion 43C and the second light emitting portion 43D and reflected by the document X1 passing through the reading position P1.

The AFE 43G converts the analog electrical signal output from the photoelectric conversion portion 43F into a digital electrical signal (image data) and outputs the digital electrical signal.

The second imaging portion 43 uses the first light emitting portion 43C and the second light emitting portion 43D to output image data including an image of the back surface of the document X1 passing through the reading position P1. The second imaging portion 43 is an example of an image sensor of the present disclosure.

The image processing portion 44 executes predetermined image processing on the image data output from the second imaging portion 43. More specifically, the image processing portion 44 is a board on which an electronic circuit for executing the image processing is mounted. For example, the image processing portion 44 is provided on the bottom surface of the housing 43A of the second imaging portion 43, and is connected to the AFE 43G via a cable. For example, the image processing includes shading correction. The image data that has undergone the image processing by the image processing portion 44 is input to the control portion 7.

As shown in FIG. 2 and FIG. 3, the shading roller 45 is provided opposite the second imaging portion 43 across the reading position P1. As shown in FIG. 2, the shading roller 45 is provided on a side of the conveying path 22A that faces the front surface of the document X1. The shading roller 45 has an outer circumferential surface colored with a predetermined reference color. For example, the reference color is white. Correction data used for the shading correction is read from the outer circumferential surface of the shading roller 45. The shading roller 45 is an example of an opposing portion of the present disclosure. Note that the opposing portion of the present disclosure is not limited to a roller-shaped member, and may be a plate-shaped member.

For example, the shading roller 45 is rotatably supported by a pair of bearing portions provided on both outer sides of the shading roller 45 in the length direction of the shading roller 45. In addition, the pair of bearing portions are supported by the housing 22 of the ADF 1 so as to be movable along the opposing direction D2 (see FIG. 3).

The moving portion 46 moves the shading roller 45 along the opposing direction D2 (see FIG. 3) toward the second imaging portion 43. The opposing direction D2 is a direction perpendicular to the front surface and back surface of the document X1. In addition, the opposing direction D2 is a direction intersecting the horizontal plane. Note that as shown in FIG. 2 and FIG. 3, the second imaging portion 43 is provided below the shading roller 45.

For example, the moving portion 46 includes a pair of cams that support the pair of bearing portions below the pair of bearing portions, and a motor that rotates the pair of cams. The pair of cams are provided so as to be rotatable together. The pair of cams rotate upon receiving a rotational driving force supplied from the motor, thereby causing the pair of bearing portions to oscillate along the opposing direction D2.

The control portion 7 corrects the orientation of the read image based on a shadow image included in the read image that is read from the document X1 using the second imaging portion 43. The shadow image is an image showing a shadow SH1 (see FIG. 3) that occurs when the leading edge of the document X1 passes through the reading position P1. More specifically, the control portion 7 rotates the read image so that the inclination angle of the shadow image with respect to the main scanning direction becomes zero.

In addition, the control portion 7 determines the size of the document X1 in the width direction perpendicular to the conveying direction D1 based on the shadow image. More specifically, the control portion 7 determines the size of the document X1 in the width direction based on the size of the shadow image in the length direction.

In the image forming apparatus 100, by replacing the second imaging portion 43 due to a breakdown or the like, the type of the second imaging portion 43 provided in the image forming apparatus 100 may be changed.

Here, when the type of the second imaging portion 43 provided in the image forming apparatus 100 is switched, the shadow SH1 (see FIG. 3) that occurs when the leading edge of the document X1 passes through the reading position P1 becomes thinner, and it may be impossible to read the shadow SH1.

More specifically, when the type of the second imaging portion 43 is switched, the incident angle AN1 (see FIG. 3) of the light emitted from the first light emitting portion 43C with respect to the document X1 may become smaller. Thus, the width W1 (see FIG. 3) of the shadow SH1 in the conveying direction D1 becomes smaller, and the shadow SH1 becomes thinner.

When reading of the shadow SH1 fails, it becomes impossible to correct the orientation of the read image based on the shadow image, and it becomes impossible to determine the size of the document X1 in the width direction.

In contrast to this, in the image forming apparatus 100 according to an embodiment of the present disclosure, it is possible to read the shadow SH1 occurring at the leading edge of the document X1 regardless of the type of the second imaging portion 43, as will be described below.

### [Configuration of Control Portion 7]

Next, the configuration of the control portion 7 will be described with reference to FIG. 1 and FIG. 3.

As shown in FIG. 1, the control portion 7 includes an identification processing portion 51 and an adjustment processing portion 52.

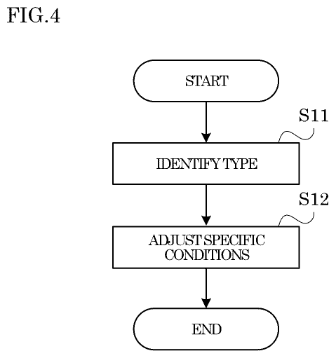

More specifically, the ROM 12 of the control portion 7 stores in advance a reading condition adjustment program for causing the CPU 11 to execute a reading condition adjustment process (see FIG. 4) described later. The CPU 11, by executing the reading condition adjustment program stored in the ROM 12, functions as the identification processing portion 51 and the adjustment processing portion 52. An apparatus including the ADF 1, the image reading portion 2, and the control portion 7 is an example of the image reading apparatus of the present disclosure.

Note that the reading condition adjustment program may be recorded on a computer-readable recording medium such as a CD, a DVD, or a flash memory, and may be read from the recording medium and stored in a storage device such as the storage portion 6. In addition, some or all of the processing portions included in the control portion 7 may be configured by electronic circuits. In addition, the reading condition adjustment program may be a program for causing a plurality of processors to function as each of the processing portions included in the control portion 7.

The identification processing portion 51 identifies the type of the second imaging portion 43.

For example, in the image forming apparatus 100, the image processing portion 44 can output a type signal corresponding to the type of the second imaging portion 43.

The identification processing portion 51 identifies the type of the second imaging portion 43 based on the type signal output from the image processing portion 44.

For example, the identification processing portion 51, based on the type signal output from the image processing portion 44, identifies whether the second imaging portion 43 provided in the image forming apparatus 100 is a second imaging portion 43 with product name A or a second imaging portion 43 with product name B.

For example, the second imaging portion 43 with product name B has a smaller incident angle AN1 (see FIG. 3) than the second imaging portion 43 with product name A. In other words, it is more difficult for the image forming apparatus 100 provided with the second imaging portion 43 with product name B to read the shadow SH1 than for the image forming apparatus 100 provided with the second imaging portion 43 with product name A.

Note that the identification processing portion 51 may identify the type of the second imaging portion 43 from among three or more types.

In addition, the second imaging portion 43 may also have a function of outputting the type information. In this case, the identification processing portion 51 may identify the type of the second imaging portion 43 based on the type signal output from the second imaging portion 43.

In addition, the second imaging portion 43 may also include a type display portion that displays the type of the second imaging portion 43 on the outer surface of the housing 43A. For example, the type display portion is a label, a barcode, or the like including information indicating the type of the second imaging portion 43. In addition, the type display portion may have a shape for identifying the type of the second imaging portion 43. In this case, the identification processing portion 51 may identify the type of the second imaging portion 43 using a reading portion capable of reading the type of the second imaging portion 43 displayed by the type display section.

Based on the identification result by the identification processing portion 51, the adjustment processing section 52, among the conditions for reading the image of the document X1 using the second imaging section 43, adjusts specific conditions related to the generation of a shadow SH1 (see FIG. 3) that occurs when the leading edge of the document X1 passes through the reading position P1.

For example, the specific conditions include a light amount ratio between the amount of light emitted by the first light emitting portion 43C and the amount of light emitted by the second light emitting portion 43D.

In addition, the specific conditions also include a separation distance in the opposing direction D2 between the second imaging portion 43 and the shading roller 45.

For example, in the image forming apparatus 100, table data correlating the type of the second imaging portion 43 with the amount of light emitted by the first light emitting portion 43C, the amount of light emitted by the second light emitting portion 43D, and the separation distance is stored in advance in the storage portion 6.

For example, in the table data, the amount of light emitted by the second light emitting portion 43D corresponding to the second imaging portion 43 with product name B is set to be smaller than the amount of light emitted by the second light emitting portion 43D corresponding to the second imaging portion 43 with product name A. Thus, when the second imaging portion 43 provided in the image forming apparatus 100 is the second imaging portion 43 with product name B (in which the shadow SH1 is relatively difficult to read), it is possible to reduce the amount of light emitted by the second light emitting portion 43D that emits light that illuminates (dilutes) the shadow SH1.

In addition, in the table data, the amount of light emitted by the first light emitting portion 43C corresponding to the second imaging portion 43 with product name B is set to be larger than the amount of light emitted by the first light emitting portion 43 corresponding to the second imaging portion 43 with product name A. As a result, when the second imaging unit 43 provided in the image forming apparatus 100 is the second imaging portion 43 with product name B (which makes the shadow SH1 relatively difficult to read), it is possible to increase the amount of light emitted by the first light emitting portion 43C that emits light that generates (darkens) the shadow SH1.

In addition, in the table data, the sum of the amount of light emitted by the first light emitting portion 43C and the amount of light emitted by the second light emitting portion 43D corresponding to the second imaging portion 43 with product name A is set to be the same as the sum of the amount of light emitted by the first light emitting portion 43C and the amount of light emitted by the second light emitting portion 43D corresponding to the second imaging portion 43 with product name B.

In addition, in the table data, the separation distance corresponding to the second imaging portion 43 with product name B is set to be larger than the separation distance corresponding to the second imaging portion 43 with product name A. Thus, when the second imaging portion 43 provided in the image forming apparatus 100 is the second imaging portion 43 with product name B (which makes it relatively difficult to read the shadow SH1), it is possible to increase the separation distance and widen the width W1 of the shadow SH1.

For example, the adjustment processing portion 52 adjusts the light amount ratio and the separation distance based on the identification result by the identification processing portion 51 and the table data. That is, the adjustment processing portion 52 adjusts the amount of light emitted by the first light emitting portion 43C to the amount of light corresponding to the identification result by the identification processing portion 51 in the table data. In addition, the adjustment processing portion 52 adjusts the amount of light emitted by the second light emitting portion 43D to the amount of light corresponding to the identification result by the identification processing portion 51 in the table data. Furthermore, the adjustment processing portion 52 uses the moving portion 46 to move the shading roller 45 so that the separation distance becomes the distance corresponding to the identification result by the identification processing portion 51 in the table data.

Note that of the light amount ratio and the separation distance the adjustment processing portion 52 may adjust only the light amount ratio. In this case, the image reading portion 2 does not need to include the moving portion 46. In addition, of the light amount ratio and the separation distance, the adjustment processing portion 52 may adjust only the separation distance. In this case, the second imaging portion 43 does not need to include the second light emitting portion 43D.

### [Reading Condition Adjustment Process]

Hereinafter, with reference to FIG. 4, a reading condition adjustment method of the present disclosure will be described along with an example of a procedure of a reading condition adjustment process executed by the control portion 7 in the image forming apparatus 100. Here, steps S11, S12, . . . represent numbers of processing procedures (steps) executed by the control portion 7. For example, the reading condition adjustment process is executed in a case in which power to the image forming apparatus 100 is turned ON. In addition, the reading condition adjustment process may be executed in a case in which a predetermined operation is received on the operation display portion 5.

### <Step S11>

First, in step S11, the control portion 7 identifies the type of the second imaging portion 43. The process of step S11 is an example of an identification step of the present disclosure, and is executed by the identification processing portion 51 of the control portion 7.

More specifically, the control portion 7, based on the type signal output from the image processing portion 44, identifies whether the second imaging portion 43 provided in the image forming apparatus 100 is a second imaging portion 43 with product name A or a second imaging portion 43 with product name B.

### <Step S12>

In step S12, the control portion 7 adjusts the specific conditions based on the identification result obtained in the process of step S11. The process of step S12 is an example of an adjustment step of the present disclosure, and is executed by the adjustment processing portion 52 of the control portion 7.

More specifically, the control portion 7 adjusts the light amount ratio and the separation distance based on the identification result from the process of step S11 and the table data.

In this way, in the image forming apparatus 100, the type of the second imaging portion 43 is identified, and the specific conditions are adjusted based on the type identification result. Thus, it possible to adjust the specific conditions relating to the generation of the shadow SH1 (see FIG. 3) in accordance with the type of the second imaging portion 43 provided in the image forming apparatus 100. Therefore, regardless of the type of the second imaging portion 43, it is possible to read the shadow SH1 occurring at the leading edge of the document X1.

### SUPPLEMENTARY NOTES

An outline of the invention extracted from the above-described embodiment will be added as supplementary notes. Note that the configurations and processing functions described in the following supplementary notes can be selected and combined in any desired manner.

### <Supplementary Note 1

An image reading apparatus including:
a document conveying portion configured to convey a document along a predetermined conveying path;
an image sensor including a first light emitting portion that emits light toward a predetermined reading position on the conveying path from a position farther upstream in a conveying direction of the document than the reading position, and configured to output image data including an image of the document passing through the reading position using the first light emitting portion;
an identification processing portion configured to identify a type of the image sensor; and
an adjustment processing portion that, based on an identification result by the identification processing portion, is configured to adjust, among reading conditions of the image of the document using the image sensor, specific conditions that are related to generation of a shadow that occurs when a leading edge of the document passes the reading position.

### Supplementary Note 2

The image reading apparatus according to supplementary note 1, including
an image processing portion configured to execute predetermined image processing on the image data output from the image sensor; wherein
the image processing portion is capable of outputting a type signal corresponding to a type of the image sensor; and
the identification processing portion identifies the type of the image sensor based on the type signal output from the image processing portion.

### Supplementary Note 3

The image reading apparatus according to supplementary note 1 or 2, wherein
the image sensor includes a second light emitting portion that emits light toward the reading position from a position farther downstream in the conveying direction than the reading position, and outputs the image data using the first light emitting portion and the second light emitting portion; and
the specific conditions include a light amount ratio between an amount of light emitted by the first light emitting portion and an amount of light emitted by the second light emitting portion.

### Supplementary Note 4

The image reading apparatus according to any one of supplementary notes 1 to 3, including
an opposing portion provided opposite the image sensor across the reading position; and
a moving portion configured to move the opposing portion along an opposing direction with respect to the image sensor; wherein
the specific conditions include a separation distance between the image sensor and the opposing portion.

### Supplementary Note 5

An image forming apparatus including
the image reading apparatus according to any one of supplementary notes 1 to 4, and configured to form an image on a sheet based on the image data output from the image reading apparatus.

### Supplementary Note 6

A reading condition adjustment method executed by an image reading apparatus including
a document conveying portion configured to convey a document along a predetermined conveying path; and
an image sensor including a first light emitting portion that emits light toward a predetermined reading position on the conveying path from a position on the conveying path farther upstream in a conveying direction of the document than the reading position, and configured to output image data including an image of the document passing through the reading position using the first light emitting portion;
the reading condition adjustment method including:
an identification step of identifying a type of the image sensor; and
an adjustment step of, based on an identification result by the identification step, adjusting, among reading conditions of the image of the document using the image sensor, specific conditions that are related to generation of a shadow that occurs when a leading edge of the document passes the reading position.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image reading apparatus comprising:
a document conveying portion configured to convey a document along a predetermined conveying path;
an image sensor including a first light emitting portion that emits light toward a predetermined reading position on the conveying path from a position farther upstream in a conveying direction of the document than the reading position, and configured to output image data including an image of the document passing through the reading position using the first light emitting portion;
an identification processing portion configured to identify a type of the image sensor; and
an adjustment processing portion that, based on an identification result by the identification processing portion, is configured to adjust, among reading conditions of the image of the document using the image sensor, specific conditions that are related to generation of a shadow that occurs when a leading edge of the document passes the reading position.

2. The image reading apparatus according to claim 1, comprising
an image processing portion configured to execute predetermined image processing on the image data output from the image sensor; wherein
the image processing portion is capable of outputting a type signal corresponding to a type of the image sensor; and
the identification processing portion identifies the type of the image sensor based on the type signal output from the image processing portion.

3. The image reading apparatus according to claim 1, wherein
the image sensor includes a second light emitting portion that emits light toward the reading position from a position farther downstream in the conveying direction than the reading position, and outputs the image data using the first light emitting portion and the second light emitting portion; and
the specific conditions include a light amount ratio between an amount of light emitted by the first light emitting portion and an amount of light emitted by the second light emitting portion.

4. The image reading apparatus according to claim 1, comprising
an opposing portion provided opposite the image sensor across the reading position; and
a moving portion configured to move the opposing portion along an opposing direction with respect to the image sensor; wherein
the specific conditions include a separation distance between the image sensor and the opposing portion.

5. An image forming apparatus comprising
the image reading apparatus according to claim 1, and configured to form an image on a sheet based on the image data output from the image reading apparatus.

6. A reading condition adjustment method executed by an image reading apparatus comprising
a document conveying portion configured to convey a document along a predetermined conveying path;
an image sensor including a first light emitting portion that emits light toward a predetermined reading position on the conveying path from a position farther upstream in a conveying direction of the document than the reading position, and configured to output image data including an image of the document passing through the reading position using the first light emitting portion;
the reading condition adjustment method comprising:
an identification step of identifying a type of the image sensor; and
an adjustment step of, based on an identification result by the identification step, adjusting, among reading conditions of the image of the document using the image sensor, specific conditions that are related to generation of a shadow that occurs when a leading edge of the document passes the reading position.
